(19) United States
(12) Patent Application Publication
(10) Pub. No.: US 2006/0268316 A1
(43) Pub. Date: Nov. 30, 2006

(54) Systems and methods for fast color processing

(76) Inventors: John Barker Condon, Berthoud, CO (US); Larry M. Ernst, Longmont, CO (US); Reinhard Heinrich Hohensee, Boulder, CO (US); Steven G. Ludwig, Boulder, CO (US); Joan L. Mitchell, Longmont, CO (US); Suzanne Landreville Price, Longmont, CO (US); Nenad Rijavec, Longmont, CO (US); Jeffrey Alan Sikkink, Longmont, CO (US); Larry David Teklits, Loveland, CO (US); John Thomas Varga, Longmont, CO (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(21) Appl. No.: 11/135,677

(22) Filed: May 24, 2005

(51) Int. Cl. G06F 3/12

(52) U.S. Cl. 358/1.15; 358/1.8

(57) ABSTRACT

Systems and methods for implementing a fast, color printer architecture are disclosed. A print processor comprises a plurality of processing units operating in parallel to process data for different layers or color planes. A connection can be formed between any processing unit and any print head of one or more printers. Any one of a plurality of the parallel processing units may be assigned to process one, some, or all of the colors of data. Consequently, each one of a plurality of print heads can be assigned to receive data from any one of a plurality of processing units.

### FIELD

The present invention is in the field of digital processing of data for presentation of text, images and graphics by a device such as a color laser printer. More particularly, the invention is in the field of distributing the workload of processing the data among a plurality of processors.

### BACKGROUND

Printer systems are configured to conduct a series of hardware and software operations on digital print data in preparation for printing. The digital print data is used by the printer to form a print image on a printing surface. Examples of printers include a scanning laser beam printer and an inkjet printer. Typically, one scan of the laser beam or inkjet across the print surface forms a row of pixels referred to as a scan row. The print image is formed by one or more print heads applying multiple scan rows being successively formed on the print surface.

Data passing through a printer pipeline generally includes text, graphics, images and combinations of these elements. The density of dot placement in modern printers is constantly increasing, particularly with color printing that requires additional bits per pixel over monochrome printing. The bandwidth required for the data pipeline to transmit the data to a printhead is correspondingly increasing. To fully utilize the increasing speed capabilities of print engines, the pipeline of a printer system must be able to transfer data fast enough to supply a continuous stream of data to the printhead(s). This allows the printer to print data continuously.

A document is generally a data collection created by an application program, such as a word processing application, that is logically subdivided into pages. A page comprises objects, such as text, images, graphical objects, and display elements that are to be displayed on one side of a sheet, subject to various formatting specifications, such as size, margins, font, color, etc. Document pages are presented on sheets. When a document is presented to a printer, the printer receives and processes a data stream that contains the document to be presented. Ideally, the data stream should produce the same document content in the same format on different printers, subject to the capabilities of the printer.

Documents may be presented by a printer or display device in either a direct mode or a print-on-demand (POD) mode. In a direct mode of printing, received data for a sheet is rasterized and then transferred to the print heads for printing of a sheet. In a POD mode of printing, some data is rasterized as received by the rasterizer, but some rasterized data is retrieved from memory as called for by a display list of elements to be printed on a sheet. These objects that are retrieved from memory are typically objects that appear once for a group of sheets that are constantly reprinted as a group.

A processor for performing rasterizing of the data receives and processes the data from the data stream to produce rasterized data and a sheet specification. A sheet specification may comprise sheet length, width, margins, and other format parameters of the sheet. The rasterized data may be stored in a local memory with a pointer to identify the location in the memory where the rasterized data is stored. The sheet specification for each sheet of the document may be stored in the same or another memory of the printer in a sheet queue. The printer then accesses and processes the sheet specification for each sheet in the sheet queue.

Based on the next sheet specification in the sheet queue, the printer locates the respective rasterized data for the sheet in the printer memory system. The printer directs the rasterized data for the sheet to the print head. The print head receives the respective rasterized data for the sheet and accordingly prints the sheet. Thus, the direct mode of printing involves printing a sheet of a document utilizing rasterized data stored locally in the printer memory. This method of printing is particularly useful for printing a large volume of simplistically formatted sheets, such as a large number of sheets printed for a billing application.

To present a document in POD mode, the printer obtains and processes the next sheet specification from the sheet queue. The printer forwards the side specification(s) for the side(s) of the sheet to a side builder within the print control unit. The side builder code retrieves the objects listed in the sheet specification for the sheet from the database and builds the data for the sheet side. After the data for the sides of a sheet are built, the built sides of the sheet are stored into a local print memory system. The printer then sends a command to the print head to print the sheet after the data for the sides are built. In response to the print command, the print head retrieves the data for the side(s) of the sheet from the print memory system and prints the sheet. Thus, the POD mode of printing involves building side(s) of a sheet from an object list stored in a sheet queue and accessing the objects stored in a database in order to build the side(s) of the sheet. This method of printing is particularly useful for printing sheets with more complex data, such as printing sheets from a book.

In a typical four-color printing system, four color print heads are provided, one for Cyan, one for Magenta, one for Yellow, and one for blacK (CMYK). FIG. 1A shows a typical color printer system 150, as exemplified in the IBM Infoprint Color 130 Plus. A main processor 160 of the print system 150 receives the print data stream, and a sheet side parser 162 parse the print data stream into logical sheet sides. One sheet side is then assigned for processing to one of several processing units 164. Processing proceeds by performing RIP and Color Conversion from the data stream color specification to CMYK. Typically 8 bits are used to describe the C,M,Y or K color level for each pixel. The C,M,Y and K data for the sheet side is stored in 4 buffers 172 used by a screen processor card 170; 1 for each color. The data is then read from the buffer and screened by screen processor 174. The intensity of each pel can be described by 1, 2 or 4 bits, this is known as the bit density. Moreover, each screen processor processes the data of a different color and is wired to a print head 180. Each color print head 180 receives data for its respective color from the corresponding screen processor wired to it.

There are several problems with this method, especially as printers become faster. For a single color sheet, one screen processor is used while the others are idle. This lowers the useful processing power of the system. The volume of data and the rate at which it must be passed through the system increases with the speed of the printer and the bit density of each pel. Typical techniques for mitigating the large amount of data include compression when data is passed to the screen processor, and using display lists as an intermediate data form, so that the entire sheet side can be described more succinctly. These techniques present additional computational burden on the processors to compress and decompress the data, thus requiring even more processors for a given print speed desired. Additionally, the speed of the printer is limited by the processing speed of the screen processor.

### SUMMARY

The problems identified above are in large part addressed by systems and methods disclosed herein for fast color printing. Embodiments implement a printer architecture comprising a plurality of parallel processing units, each processing unit adapted to process data of at least one color to be printed on a sheet. The parallel processing units serve a plurality of print heads, each print head adapted to print a different one of a plurality of colors. A switch controllably forms connections to transfer data between processing units and print heads, so that a processing unit may provide data to more than one print head, and so that a print head may receive data from different processing units in succession.

In one embodiment, a print processor comprises a head node to receive a print. data stream and to distribute data to be processed to each of a plurality of processing units. The print processor further comprises a plurality of parallel processing units to receive and process data from the head node. A switch forms connections between a plurality of processing units and a plurality of print heads, so that a processing unit may be connected to more than one print head, and so that a print head may receive data from more than one processing unit sequentially.

Another embodiment is a method for distributing print data for processing and printing. The method comprises receiving print data for a sheet, the print data comprising sheet side data for a plurality of sheet sides. The method further comprises interpreting the received print data to determine data for each of a plurality of sheet sides. Sheet side data for each sheet side received is distributed to at least one of a plurality of parallel processing units, so that any one of a plurality of the processing units may receive data for at least one sheet side. The method further comprises forming a connection between a parallel processing unit and a print head to transfer processed sheet side data from the processing unit to the print heads.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1A depicts a prior art printer system.

FIG. 1 depicts a print processor that receives a print data stream from a print server and is connected to a plurality of print heads.

FIG. 2 depicts a head node with a blade controller to control assignment of data to a plurality of parallel processing units.

FIG. 3 depicts a parallel processing unit or blade for processing color plane data and object data.

FIG. 4 depicts a print head with a buffer and data decompressor.

FIG. 5 depicts a flow chart of an embodiment to provide fast color processing.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Embodiments include systems and methods for fast color printing. A print processor comprises a plurality of processing units operating in parallel to process data for different sheet sides. A switch may form a connection between any processing unit and any print head of one or more printers. Any one of a plurality of the parallel processing units may be assigned to process a sheet side. Consequently, each one of a plurality of print heads can be assigned to receive data from any one of a plurality of processing units. The system is scalable. Processing bandwidth is increased by including more processing units and the required input/output bandwidth per processing unit is reduced.

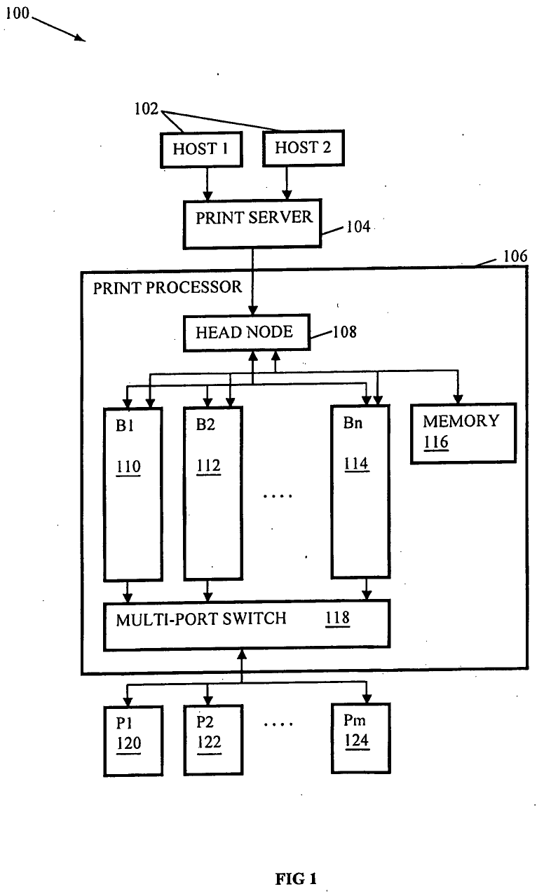

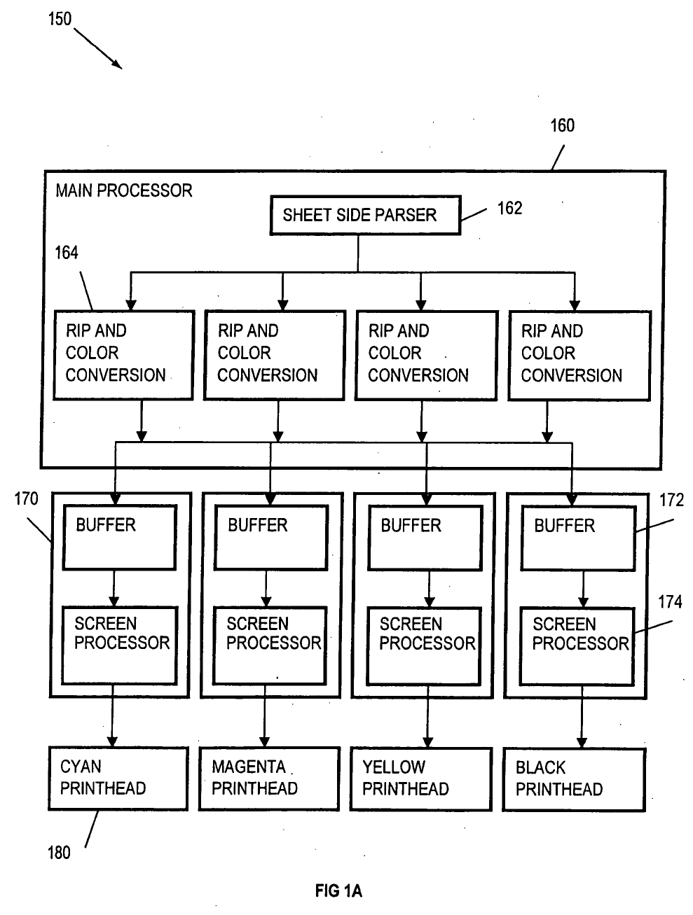

FIG. 1 shows an embodiment of a printing system 100. A print server 104 manages the transfer of print information to a print processor 106. Print server 104 may receive print data from one or more hosts 102 depicted by Host 1 and Host 2 in FIG. 1. A host is typically a computer or a workstation running an application program capable of generating, and directing to be printed, text, graphics, etc. Print server 104 may also receive status information from print processor 106. Print server 104 may perform basic tasks, such as monitoring and configuring attached printers, and providing print job management. Print server 104 and print processor 106 may also be able to synchronize at a command or page-level according to an acknowledgment protocol which provides for the exchange of host initiated queries and server reply information. Print server 104 may be a stand-alone device receiving print data from multiple workstations or computers. Or print server 104 may be incorporated within a workstation, computer, or other piece of equipment that generates data for printing. Moreover, print server 104 may serve a plurality of print processors. Thus, print server 104 provides a data stream to print processor 106 and may provide data streams to other print processors not shown in FIG. 1.

Among the functions typically provided by a print server is the conversion of the data stream containing the print data received from a computer or work station into a data stream supported by the printer to which the print data is destined. A data stream provided to the print server is highly structured to communicate what is to be printed on each side of each sheet to be printed in a print job. An exemplary data stream may employ the Mixed Object Document Content Architecture (MO:DCA) developed by International Business Machines (“IBM”) Corporation of Armonk, N.Y.

A data stream provided by the print server to a printer is likewise highly structured and depends upon the page description language employed to form the data stream. A page description language is a programming language understood by a printer that allows compact, flexible and device-independent description of a page. A print file in a page description language lists the text and graphics to be printed on the page. The description of the objects to be printed must be converted into a raster bitmap in a process called rasterization in order to be printed.

Thus, different printer manufacturers may design their printers to receive and interpret data in a common page description language. Conversely, the print server may, for example, provide an Intelligent Printer Data Stream (IPDS) to one type of printer structured to receive and interpret the IPDS, and the print sever may provide a Post Script data stream to another type of printer structured to receive and interpret the Post Script data stream. Other data streams that may be provided by print server 104 include Hewlett Packard Printer Control Language (PCL), Hewlett Packard Graphics Language (HPGL), Printer Job Language (PJL), or Apple Talk Printer Access Protocol (PAP). A preferable data stream comprises a standardized set of controls transmitted with raw data that specify how the data is to be presented by the printer.

Thus, in response to receipt of a print job within the data stream, print server 104 translates the print file into an appropriate presentation data stream, such as IPDS. Print processor 106 receives the presentation data stream and may buffer the data stream before passing it to a head node 108. Head node 108 interprets the data received from print server 106. Thus, head node 108 will parse the data and identify print files comprising sheets of data to be printed. Head node 108 may accordingly generate a display list of elements to be displayed on a sheet side. Head node 108 transfers the display list and associated data to a processing unit, herein referred to as a blade, for processing. Head node 108 may also rasterize data and store the rasterized data in a memory 116. Memory 116 may be implemented in a storage array such as the IBM TotalStorage® DS400. Head node 108 may also send rasterized data to a blade. Rasterization is the process of converting data into an ordered bitmap communicable to the print heads to cause the data to be printed in a raster pattern. This process enables the page to be printed by the print engine, which generally prints the page line by line from one edge to an opposite edge of a sheet.

Head node 108 distributes data for a sheet side to one of a plurality of blades B1 through Bn where n is an integer. Thus, a blade may receive from head node 108 a display list and associated data for a sheet side. Three blades 110, 112, and 114 are shown in FIG. 1, but persons of skill in the art will understand that any practical number of blades performing functions described herein may be employed. In one embodiment, each blade is a processing unit that can serve eight print heads. The term blade generally refers to a printed circuit board that may be inserted into a slot. A chassis of a print processor may comprise rows of slots, each slot receiving a different blade. The blades may be connected to head node 108 by way of a TCP/IP connection or other type of connection that allows the head node to communicate with each blade. In one embodiment, each blade can process four color planes or layers comprising, for example, Cyan, Magenta, Yellow, and Black (CMYK). A blade may also process multiple layers of objects, text and graphics. A blade may further perform color conversion and halftone conversion. Thus, multiple print heads may be served by multiple blades. The print heads may be color, may provide magnetic toner, or glossy coating or ultra-violet ink.

Thus, head node 108 distributes the work of processing sheets of data to the blades. Each blade may process one or more different layers of data corresponding to a sheet side. For example, a blade may process one or more or all of the color planes for a sheet side. In one embodiment, each blade simultaneously processes sheet side data for a different sheet side. In another embodiment, one blade may process one color plane for a sheet while the other color planes for the sheet are processed by other blades. Head node 108 therefore may distribute the work of different layers to different blades. Generally, head node 108 will distribute the work load to the processing units as evenly as practicable to increase processing efficiency. Thus, the blades form a plurality of parallel processors that receive work, (data and instructions), from the head node, to be processed in parallel. In one embodiment, four blades are provided, each blade capable of processing up to four colors. Thus, up to four sheet sides can be processed in parallel for the four-blade embodiment.

Each blade is in communication with a multi-port switch 118. Multi-port switch 118 can form multiple simultaneous connections between the blades and the printheads. An exemplary switch is the IBM TotalStorage® SAN Switch F16. Multi-port switch 118 can connect any one of the n blades to any one of m print heads, P1, P2, . . . Pm, labeled 120, 122, . . . 124, where m is an integer. Multi-port switch 118 can also communicate information from one blade to another. Since any blade can be connected to any print head, head node 108 may assign a sheet side to any one of the blades. For example, head node 108 may assign a blade to process one sheet side while assigning another blade to process another sheet side simultaneously. All four printheads may receive data from one blade for printing one sheet side, and then receive data from a next blade for printing a next sheet side. Thus, a color print head may receive data from different blades in succession. In another embodiment, a first blade may be assigned to process the color cyan for a first sheet and a second blade may be assigned to process the color cyan for a second sheet. The cyan print head would then receive data first from the first blade and then from the second blade.

In one embodiment, each blade can serve up to four print heads simultaneously. Thus, one blade can be assigned to process all four colors of a sheet side in a four-color system. In another embodiment, the processing for the data of different colors for a sheet may be distributed to more than one blade. Note also, that print processor 106 may serve more than one printer. For example, four of the print heads connected to switch 118 may be located in one printer and four of the print heads connected to switch 118 may be located in another printer. In such a configuration, head node 108 can distribute the work of two different printers among the plurality of blades, and ensure that the output of the blades go to the correct print heads of each printer. In one embodiment the two printers are coupled together to print one side of sheets in the first printer and the reverse sides of sheets in the second printer. In an alternative embodiment, four print heads connected to switch 118 may be located in four black/white printers or the front or back sides in two printers. Instead of four colors calling for four print heads in one printer, the four printers each have only one or two print heads. If at least one printer runs higher priority jobs and at least another printer is cut sheet and can be stopped and started with no penalty, then the head node can stop distributing the cut sheet printer sheets anytime the higher priority printer needs extra processing nodes.

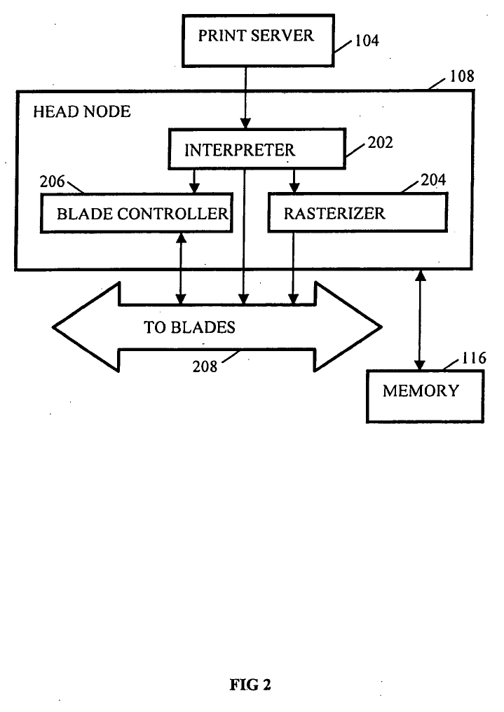

FIG. 2 shows a head node 108 receiving a print data stream from print server 104 as described above. In one embodiment, head node 108 comprises an interpreter 202 that provides a first level of interpretation of the information in the data stream received from print server 104. Data may be may be received in Write Object Containers (WOC) each associated with a different WOC Control (WOCC). Interpreter 202 may prepare a display list of elements to be displayed on a sheet side for each side of each of a succession of sheets to be printed. For each element in the display list, interpreter 202 associates the data corresponding to the element. Interpreter 202 transmits a display list and the associated data for each element in the list to a blade by way of a connection 208 between the head node and the blades.

Head node 108 also comprises a rasterizer 204. Rasterizer 204 may receive and rasterize data corresponding to certain graphics. For example, rasterizer 204 may rasterize text and barcodes and store the results in memory 116. One or more blades may later access these results from memory 116. Thus, memory enables sharing of data and commonly used resources between the head node and the blades. Rasterizer 204 may also transmit rasterized data to a blade by way of connection 208. As noted above, connection 208 may be a TCP/IP connection. Thus, interpreter 202 parses the input data stream and creates drawing primitives, termed display list elements. Rasterizer 204 may render elements of a sheet within the print data stream into a presentation-ready format, such as a bit-mapped format compatible with the printer hardware.

Head node 108 further comprises a blade controller 206. Blade controller 206 controls assignment of sheet side data and instructions to the blades. Blade controller 206 may also coordinate the switching between blades and print heads. Blade controller 206 may receive status information concerning the state of completion of processing of sheet data in a blade. Blade controller 206 determines how to divide up the work of processing the data for a sheet among the various available blades. For example, blade controller 206 may assign one sheet side of data to one blade for processing and assign another sheet side of data to another blade for processing.

Through switch 118, each print head may receive data from any one of the blades at a time. Thus, processed sheet data from a blade is assigned to the appropriate print head. For example, in preparation for printing a sheet, a cyan print head will receive data from a blade assigned to process data to be printed in cyan. Similarly, the magenta print head may receive its data from the same blade or a different blade. In one embodiment, each blade may process data for up to four print heads. Correspondingly, each blade may process one, some, or all of the four colors (CMYK) corresponding to four different print heads, one for each color, in a four-color system. Thus, when processing a sequence of sheets, a print head will receive data from different blades in a sequence that can be controlled.

In one embodiment, the head node passes to a blade, along with the display list and data for a sheet, a print head pointer. The print head pointer points to the print head that is to receive the data from the blade. When time arrives to pass the data from a blade to a print head, the switch receives from the blade, the print head pointer. The print head pointer tells the switch which print head to connect the blade to. In another embodiment, the head node may pass a blade pointer to the print head indicating which blade to receive data from next. The head node may pass this pointer directly to the print head or to the print head through the blade. The print head passes the blade pointer to the switch, causing the switch to form a connection between the indicated blade and the print head. In yet another embodiment, the head node passes a blade pointer and a print head pointer to the switch to inform the switch of the connection to be made between blade and print head.

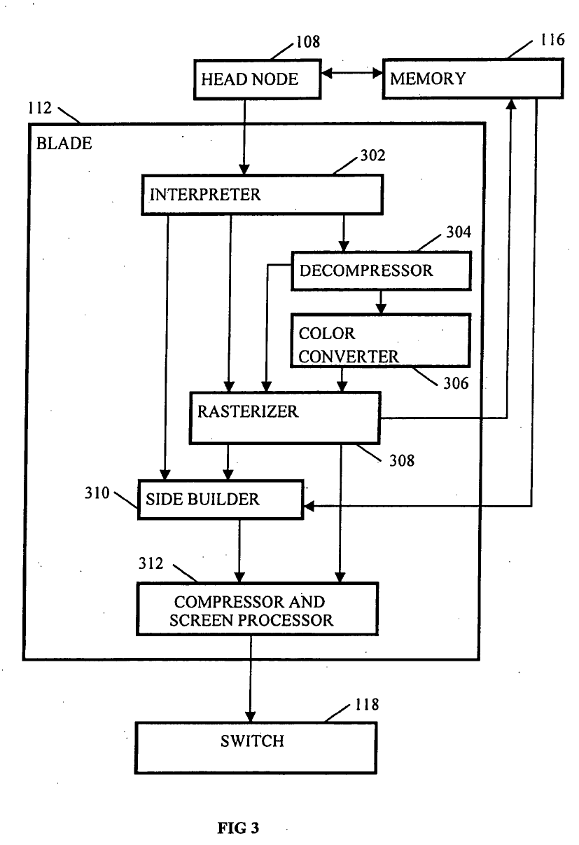

FIG. 3 shows one embodiment of a blade such as blade 112. Blade 112 is in communication with head node 108, memory 116, and switch 118. Blade 112 receives display lists and associated data from head node 108. The data stream that blade 112 receives may be JPEG, Post Script or other format for providing data for presentation of graphics, text, etc. An interpreter 302 receives the data stream and interprets the manner of presentation and what is to be printed. For example, embedded in the data stream will be data indicating where to place each object on the sheet. Also, the data will include sheet size, etc.

The data for presentation may be compressed by a host 102. Consequently, blade 112 provides a decompressor 304 to decompress the presentation data. A color converter 306 is available to perform color conversion, if called for, on the uncompressed data. In a general four-color printing device, printing is performed using cyan, magenta, yellow and black (C, M, Y, K). Accordingly, in performing color printing, there is an operation of color conversion from the three primary colors of red, green and blue (R, G, B) to the four colors of cyan, magenta yellow and black (C, M, Y, K), and also an operation of gray scale conversion from a gray scale display to a display having only solid black and white with no ability to reproduce gray tones directly (without using a screen or halftone mask). To perform the color conversion, an optional correspondence is established between the coordinates of RGB space and the coordinates of CMYK space, so that an optional point in RGB space corresponds to a point in CMYK space.

A rasterizer 308 rasterizes the data before transfer through switch 118. In an alternative embodiment, color converter 306 may follow rasterizer 308 to perform color conversion of the rasterized data before transfer through the switch. Further, blade 112 may copy rasterized data to memory 116 for reuse in subsequent sheets. Rasterizer 308 may comprise a plurality of rasterizers for rasterizing different layers or color planes. Thus, in one embodiment rasterizer 308 comprises four rasterizers for simultaneous separate rasterization of data for each of the colors: Cyan, Magenta, Yellow, Black (CMYK). Blade 112 further comprises a screen processor for merging and screening operations and a compressor 312 to compress data before transfer to a print head.

When a printer operates in direct mode, rasterizer 308 rasterizes the data within the decompressed received data stream to generate rasterized data (i.e., text, graphics, objects, bar codes, fonts, etc.). Interpreter 302 also generates a sheet specification (e.g., length, width, margins and other format parameters of the sheet) for the current sheet of the document being processed by blade 112. The rasterized data for the direct mode may be then compressed and transferred through switch 118. In the direct mode of printing, the rasterized data from rasterizer 308 is in a renderable format that is directly printable by a print head. Rasterizer 308 pre-processes the data so that each side of the sheet has already been built prior to sending the rasterized data to the print head. The sheet specification for each sheet of the document is sent to the print head to control printing of the sheet. The print head receives the sheet specification and the rasterized data for the sheet and prints the sheet. Thus, the direct mode of printing involves printing a sheet by directly presenting the rasterized data from rasterizer 308, (but for compression and decompression.)

Blade 112 may further comprise a side builder 310. Blade 112 may use side builder 310 in a Print on Demand (POD) mode to build a sheet side prior to printing. In a POD mode, side builder 310 retrieves rasterized object data from memory 116 as called for according to the display list. Side builder 310 also receives rasterized data from rasterizer 308 corresponding to elements from the display list. Thus, side builder 310 may retrieve element data from memory 116 and/or receive it from rasterizer 308. Side builder 310 assembles a sheet according to the display list and transfers the assembled sheet data to compressor 312. The side builder 310 may also receive display list data from memory 116 similar to interpreter 302, and so may contain an interpreter, decompressor, color converter, and rasterizer internal to the side builder.

For example, a page may include one or more overlays. An overlay is a pre-defined page or part of a page that head node 108 or a blade's rasterizer 308 sends to local memory 116. An overlay may include text, images, graphics, bar codes, and/or other objects. Overlays may be stored in the local print processor memory until they are deactivated. Overlays are typically used to present fixed data on a document that does not move from sheet to sheet. An overlay may be included in a page by specifying in the data for the page a command to include the overlay. Side builder 310 may receive rasterized overlays from memory 116. Or rasterizer 308 may receive overlay data from memory 316 and rasterize it before sending it to side builder 310.

Other components of blade 112, such as a halftone generator are not shown. Persons of skill in the art will recognize that functions depicted by the functional blocks shown in the figures may be implemented by a processor. Thus, a processor may operate under the directions of software to perform functions including color conversion, data compression and decompression, side-building, rasterization and halftone generation. Also, a local cache memory on each blade may be provided for rapid access of data and instructions. Thus, the processor may receive instructions from an instruction cache and communicate data to and from a data cache. The processor may comprise an instruction fetcher, an instruction buffer, a dispatch unit, several execution units including at least one arithmetic/logic unit, and a completion unit. Artisans of ordinary skill will further understand that the term blade, as used herein, may be any processing unit such that the processing units may operate in parallel between the head node and the switch. Because the switch can connect any one of a plurality of print heads to any one of a plurality of processing units, different layers of sheet data can be processed by different blades and delivered to any of the print heads.

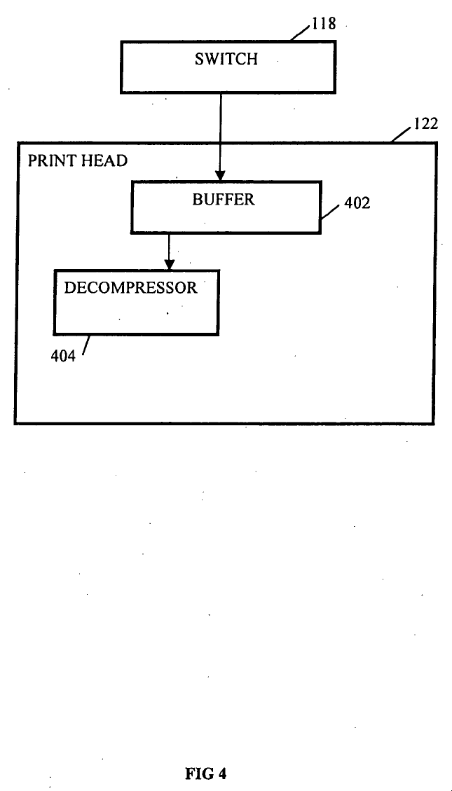

FIG. 4 shows one embodiment of a print head such as print head 122. A buffer 402 receives compressed data and sheet specification data for printing a sheet from one of a plurality of blades connected to the print head through switch 118. A decompressor 404 decompresses the presentation data. The print head outputs the decompressed presentation data by putting ink, toner or dye on the sheet.

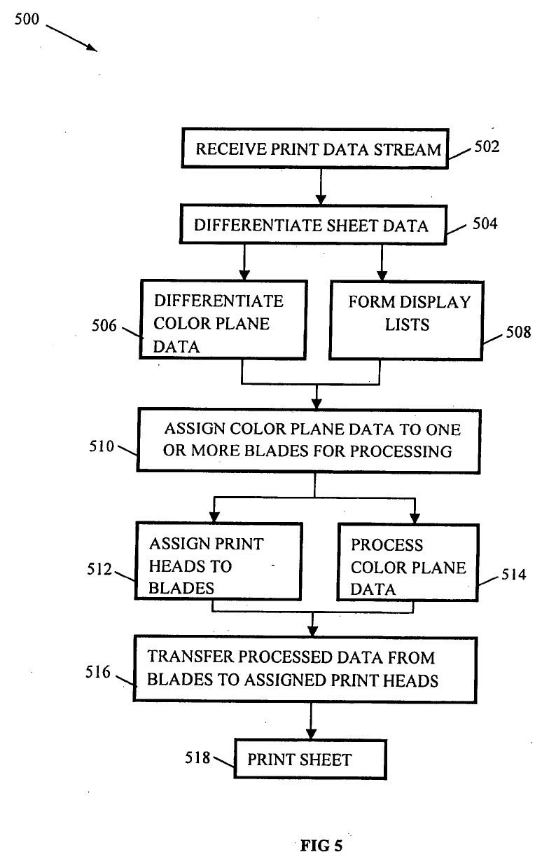

FIG. 5 shows a flowchart 500 of an embodiment for fast color processing. Flowchart 500 may be viewed as a processing pipeline comprising parallel processes. A print processor receives a data stream (element 502). The print processor interprets the data and differentiates between sheets of data (element 504). From the differentiated sheet data, the print processor may further differentiate the data of each of a plurality of color planes (element 506). Also from the differentiated sheet data, the print processor forms a display list for each sheet as the data enters the pipeline (element 508). Subsequently or simultaneously, the print processor will assign sheet side data to one or more parallel processing units for processing (element 510). The assignment of blades is interchangeable. The print processor also assigns print heads to blades (element 512). That is, any of a plurality of blades can be assigned to process the data of any of a plurality of sheet sides. Thus, all four print heads will receive data from one blade for printing a sheet side, and then receive data from a different blade for printing a next sheet side.

In another embodiment, the print processor can assign print heads to blades (element 512) based on which blade has been assigned which colors for a sheet. For example, if cyan and magenta are assigned to blade 1, and yellow and black are assigned to blade 2, then the cyan print head and the magenta print head will be assigned to receive data from blade 1 and the yellow print head and the black print head will be assigned to receive data from blade 2. In a next subsequent sheet, different blades may be assigned the colors and different print heads will, consequently, be assigned to different blades. Each blade will process its assigned color plane(s) (element 514). When the processing is complete, the data from a blade is transferred to the print heads assigned to receive data from that blade (element 516). When the data for a sheet is ready in the print heads, the printer prints the sheets (element 518). Since a blade is only connected to one print head at a time, the head node assigns print heads to blades and sheet sides to blades so that there are no bottlenecks in having data for a print head delayed because the blade is busy sending data to another print head.

Thus, embodiments comprise a plurality of processing units, each processing unit capable of processing data corresponding to a sheet side and different colors and each processing unit capable of processing up to four colors. A head node assigns sheet side data for each one of a plurality of sheets received in the print data stream to one or more of the processing units. One processor may therefore be processing sheet data for one sheet and another processor may be processing sheet data for a different sheet. In an embodiment, the head node assigns the sheet data for the sheets to the processors in such a way as to maximize the use of processing power, keeping as many of the processors as busy as possible. This is possible because each print head can be assigned to any one of the processors. In an embodiment, the head node coordinates the transfer of the data from a blade to the correct print head(s). This may be accomplished using a pointer to a next blade from which data is to be received by a print head and/or a pointer to the print head(s) to receive data from a blade.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A printer architecture, comprising:
a plurality of parallel processing units connected to a switch, each processing unit adapted to process sets of data to be printed on sheets;
a plurality of print heads connected to the switch, each print head adapted to print a set of data processed by the parallel processing units; and
a switch connected to the plurality of parallel processing units and to the plurality of print heads to transfer data from the parallel processing units to the print heads; the switch responsive to control information so that data of a particular data set processed by any one of a plurality of the processing units may be transferred to a print head adapted to print that data set, and so that a print head can receive data sets from different processing units in succession.

2. The printer architecture of claim 1, further comprising a head node connected to a plurality of the parallel processing units to receive data and instructions from a print data stream and to distribute data of a plurality of data sets to a plurality of the parallel processing units for simultaneous processing of the data sets by the parallel processing units.

3. The printer architecture of claim 2, wherein the head node further comprises an interpreter to interpret instructions received from the print data stream by the head node.

4. The printer architecture of claim 2, wherein a processing unit further comprises a rasterizer to rasterize data received from the print data stream.

5. The printer architecture of claim 1, further comprising a memory accessible by a plurality of the parallel processing units for sharing data.

6. The printer architecture of claim 1, wherein at least one of the parallel processing units comprises a rasterizer for rasterizing data for at least one of the plurality of colors.

7. The printer architecture of claim 1, wherein at least one of the parallel processing units comprises a color converter to convert between color formats.

8. A print processor, comprising:
a head node to receive a print data stream, to distribute data of the print data stream to each of a plurality of processing units, and to generate control information to control the transfer of processed data from the processing units to a plurality of print heads;
a plurality of processing units connected to the head node to receive and process the data of the print data stream from the head node; and
a switch connected to the processing units and to the print heads to transfer data from the processing units to the print heads; the switch responsive to the control information to determine which print heads connect to which processing units, enabling data of a particular data set to be processed by any one of a plurality of the processing units and transferred to a print head adapted to print that particular data set, and enabling a print head to receive data of the data set the print head is adapted to print from different processing units in succession.

9. The print processor of claim 8, further comprising a memory accessible to a plurality of the parallel processing units to share data received from the head node.

10. The print processor of claim 8, wherein a plurality of the processing units each comprise a rasterizer to rasterize data received from the head node.

11. The print processor of claim 8, wherein each one of a plurality of the parallel processing units can be interchangeably assigned to process the data of at least one color for a sheet.

12. The print processor of claim 8, wherein the switch determines a connection between one of the parallel processing units and one of the print heads according to a pointer received from that one processing unit.

13. The print processor of claim 8, wherein the switch determines a connection between one of the parallel processing units and one of the print heads according to a pointer received from that one print head.

14. The print processor of claim 8, wherein the switch determines a connection between one of the parallel processing units and one of the print heads according to address information received from the head node.

15. A method for distributing print data for processing and printing, comprising:
receiving print data for a sheet, the print data comprising sheet side data for a plurality of sheets;
interpreting the received print data to determine sheet side data for each of a plurality of sheets;
distributing the sheet side data for each of the plurality of sheet sides to at least one of a plurality of parallel processing units, so that any one of a plurality of the parallel processing units may receive data for a sheet side; and
forming a connection between one of the parallel processing units and at least one of the print heads to transfer processed sheet side data from the parallel processing unit to the at least one print head.

16. The method of claim 15, further comprising passing an address of one of the parallel processing units from a print head to a switch to form a connection between one of the print heads and the processing unit.

17. The method of claim 15, further comprising passing an address of one of the print heads from a parallel processing unit to a switch to form a connection between one of the parallel processing units and the print head.

18. The method of claim 15, further comprising processing the data received by each parallel processing unit to produce rasterized color plane data in the parallel processing unit.

19. The method of claim 15, wherein processed sheet side data may be transferred to any one of a plurality of printers.

20. The method of claim 15, wherein distributing the sheet side data for each of the plurality of sheet sides comprises interchangeably assigning at least one of plurality of parallel processing units to process data for different ones of a plurality of color planes.
